(19) United States
(12) Patent Application Publication
(10) Pub. No.: US 2010/0148710 A1
(43) Pub. Date: Jun. 17, 2010

(54) APPARATUS AND METHOD FOR CONTROLLING A BLDC MOTOR

(75) Inventors: Sun-Kyoung Lim, Seoul (KR); Ki-Bok Lee, Seoul (KR); Jun-Bo Yun, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/640,735

(22) Filed: Dec. 17, 2009

(30) Foreign Application Priority Data
Dec. 17, 2008 (KR) 10-2008-0128850
Dec. 17, 2008 (KR) 10-2008-0128851

(51) Int. Cl. H02P 6/20; H02P 6/08

(52) U.S. Cl. 318/400.11; 318/400.13

(57) ABSTRACT

An apparatus for controlling a BLDC motor includes a frequency controller configured to increase frequency of a drive signal that is applied to the motor to reach a first target speed at a relatively low speed region. The apparatus also includes a sensorless controller configured to observe location of a rotor of the motor at the low speed region, and provide a control signal to the motor by comparing a command speed with an estimated speed based on detection of a voltage and/or a current of the motor at a relatively high speed region. Further, the apparatus includes a control unit configured to select one of the frequency controller and the sensorless controller based on the speed of the motor.

### CROSS-REFERENCE RELATED APPLICATIONS

The present application claims the benefit of priority to Korean Application No. 10-2008-0128850, filed on Dec. 17, 2008 and Korean Application No. 10-2008-0128851, filed on Dec. 17, 2008, which are herein expressly incorporated by references in their entirety.

### FIELD

The present disclosure relates to BLDC (Brushless DC) motor control technology

### BACKGROUND

BLDC motors are widely used not only in home appliance products such as a refrigerator, an air conditioning system, and the like, but also in information processing system such as a floppy disk drive. A separate detection device is provided in a BLDC motor in order to detect the revolution speed, the location of rotor, and the like. However, a sensorless BLDC motor does not need this detection device.

A typical sensorless BLDC motor may include three U, V, and W coils 11, 12, 13 respectively and a rotor 14 as shown in FIG. 1. Furthermore, there are two types of methods for controlling the revolution speed of such a motor, such as 120-degree conduction method and 180-degree conduction method.

First, the 120-degree conduction method is a method in which high (H), low (L), and open (O) phase voltages are alternately applied to each coil of a motor, and a magnetic force generated by those voltages rotates a rotor of the motor, thereby controlling the motor speed. Second, the 180-degree conduction method is a method in which the revolution speed of a motor is estimated through a speed estimator without receiving a feedback of the revolution speed from the motor, thereby controlling the revolution speed of the motor. The 180-degree conduction method is called a vector control method.

A drive circuit of a BLDC motor of FIG. 1 is shown in FIG. 2. A power supply unit 21 converts alternating voltage, which is a commercial power supply 20, into direct voltage. A pulse-width modulation unit 23 generates a switching control signal. A switching element 24 converts the direct voltage supplied from the power supply unit 21 into a 3-phase voltage based on the switching control signal in order to apply it to a motor 10. Windings 11, 12 and 13 of the motor 10 generate a magnetic force by the 3-phase voltage to rotate a rotor 14 of the motor 10.

A counter electromotive force is outputted by the windings based on the revolution of the motor rotor, and a counter electromotive force detection unit 27 detects the counter electromotive force and supplies the detected counter electromotive force to a microcomputer 25. Based on the detected counter electromotive force, the microcomputer 25 controls the pulse-width modulation unit 23 to accurately operate the motor. Furthermore, the microcomputer 25 receives a current value applied to the motor 10 from a current detection unit 26 for detecting a current at an output stage of the switching element 24. Also, the microcomputer 25 detects a voltage supplied from a voltage detection unit 22 for detecting a voltage of the power supply unit 21. The microprocessor may block the DC power source in the power supply unit 21 when a level of the voltage or current is detected as too high.

A counter electromotive force is generated while rotating the motor, and the counter electromotive force may increase as the revolution speed of the motor increases. A location detection unit 25a calculates the location of a motor rotor based on the current being applied to the motor 10. The current is detected by the current detection unit 26 and the counter electromotive force detection unit 27 that is at an output stage of the switching element 24. A speed controller 25b controls the revolution speed of the motor based on the output current, the counter electromotive force, and the like.

In general, the step of driving a BLDC motor may be divided into three sections, such as an initial location setting section, an open loop section, and a closed loop section. The initial location setting section is a section in which a rotor starts to rotate from the stop state until the rotor is moved to a preset location, the open loop section is a low-speed section in which a counter electromotive force is not detected after an initial location of the rotor is set, and the closed loop section is a section in which the a counter electromotive force can be detected to implement a normal control of the rotor.

According to a 180-degree conduction method in the related art, in order to start a sensorless BLDC motor, a predetermined amount of current is initially applied to the U-phase thereof for a predetermined period of time to align a rotor of the BLDC motor to the U-phase thereof, and then the motor is started directly through a senseless control. In other words, the location of the rotor is assumed to be “0” in a state that the rotor of the BLDC motor is aligned at the U-phase, and this location is set to a reference location to control the motor speed directly through the location of the rotor using a senseless control.

In case of controlling the speed of a BLDC motor in this manner, the motor may be in a high-load state at the initial alignment, or the location of a motor rotor may not be aligned at the reference location, and the alignment may not be achieved in a perfect manner when positioned adjacent to the reference location. If a motor is controlled by a senseless algorithm in this imperfect initial to alignment state of a motor rotor, then a start-up of the motor may be failed due to an initial location error of the motor rotor.

### SUMMARY

In one aspect, an apparatus for controlling a BLDC motor may include a PWM controller configured to control the on/off of an inverter providing a drive voltage to a motor, a voltage/frequency controller configured to output a low-speed control signal to the PWM controller for allowing a frequency of the voltage applied to the motor to follow a command speed, a sensorless controller configured to output a high-speed control signal to the PWM controller for allowing the motor speed to follow the command speed by comparing the command speed with an estimated speed based on a voltage or current of the motor, and a control algorithm switching unit configured to select the voltage/frequency controller or the sensorless controller based on the speed of the motor.

It may be implemented in that the control algorithm switching unit selects the voltage/frequency controller to control the motor speed when the command speed corresponds to a relatively low-speed region.

It may be implemented in that the control algorithm switching unit selects the sensorless controller to control the motor speed when the command speed corresponds to a relatively high-speed region.

It may be implemented in that the voltage/frequency controller controls the motor speed and the sensorless controller observes the location of a rotor of the motor when the command speed corresponds to a region between the to low-speed region and the high-speed region.

It may be implemented in that the control algorithm switching unit comprises a switch for selecting a controller of the motor based on the command speed.

It may be implemented in that the voltage/frequency controller increases frequency of the applied voltage to reach the command speed, and increases a size of the applied voltage in proportion to the counter electromotive force until the motor speed passes the low-speed region including the stop state.

It may be implemented in that the sensorless controller controls the motor speed to follow the command speed by comparing an estimated speed based on a current and voltage of the motor with the command speed after the motor speed reaches the high-speed region.

In another aspect, a BLDC motor control apparatus may include a PWM controller configured to control the on/off of an inverter providing a drive voltage of a motor, a current/frequency controller configured to control the motor speed by outputting a low-speed control signal to the PWM controller according to a frequency of an applied current based on an command speed, a sensorless controller configured to control the motor speed by outputting a high-speed control signal to the PWM controller based on a compared difference between an command speed of the motor and an estimated speed of the motor, and a control algorithm switching unit configured to select the current/frequency controller or the sensorless controller as a controller of the motor based on the motor speed.

It may be implemented in that the current/frequency controller maintains a current applied to the motor within a rated range.

It may be implemented in that the control algorithm switching unit selects the current/frequency controller to control the motor speed when the motor speed corresponds to a low-speed region.

It may be implemented in that the control algorithm switching unit selects the sensorless controller to control the motor speed when the motor speed corresponds to a high-speed region.

It may be implemented in that the current/frequency controller controls the motor speed and the sensorless controller observes the location of a rotor of the motor when the motor is driven in a region between the low-speed region and the high-speed region.

It may be implemented in that the control algorithm switching unit comprises a switch for selecting a controller of the motor based on the command speed of the motor.

It may be implemented in that the current/frequency controller increases frequency of the applied current until the motor speed reaches a command speed of the motor while the motor is driven within a low-speed region including the stop state.

It may be implemented in that the sensorless controller controls the motor speed to follow the command speed by comparing an estimated speed of the motor based on a current and voltage of the motor and a command speed of the motor after the motor speed reaches the high-speed region.

It may be implemented in that the motor is a sensorless BLDC motor with a 180-degree conduction method.

In yet another aspect, a method for controlling a BLDC motor may include a first step of increasing frequency of the applied voltage for allowing a motor speed to follow an command speed, a second step of increasing frequency of the applied voltage for allowing the motor speed to follow an command speed and observing the position of a rotor of the motor, and a third step of controlling the motor speed to follow the command speed based on a compared difference between the speed estimated by a current and voltage of the motor and the command speed.

It may be implemented in that the second step include a speed increase step of increasing frequency and size of the applied voltage until the motor speed reaches the high-speed region; and a rotor location observation step of observing the location of a rotor of the motor based on a current and voltage of the motor.

It may be implemented in that the third step include a step of switching the motor speed control mode from a frequency control of the applied voltage to an estimated speed control thereof when the motor speed reaches the high-speed region; and a sensorless control step of estimating and controlling the motor speed based on the observed location of the motor rotor.

It may be implemented in that the motor speed is calculated by a frequency of the applied voltage in the first step or the second step.

It may be implemented in that the size of the applied voltage is maintained at a fixed level, and the frequency of the applied voltage is increased in the first step or the second step.

It may be implemented in that the motor is a sensorless BLDC motor with a 180-degree conduction method.

In yet another aspect, a method for controlling a BLDC motor may include a low-speed control step of increasing the motor speed according to a frequency of the applied current based on an command speed, a parallel control step of controlling the motor speed according to a frequency of the applied voltage and observing the position of a rotor of the motor, and a high-speed control step of controlling the motor speed based on a compared difference between an estimated speed of the motor estimated by a current and voltage of the motor and an command speed of the motor.

It may be implemented in that the low-speed control step includes a step of increasing frequency of the applied current according to the command speed in a low-speed region, and a step of maintaining a size of the applied current within a rated current range of the motor.

It may be implemented in that the parallel control step includes a step of increasing frequency of the applied current until the motor speed reaches the high-speed region, and a rotor location observation step of observing the location of a rotor of the motor based on a current and voltage of the motor.

It may be implemented in that the high-speed control step includes a step of switching the motor speed control mode to a sensorless control based on an observed location of the motor rotor when the motor speed reaches the high-speed region, and a sensorless control step of estimating and controlling the motor speed based on the observed location of the motor rotor.

It may be implemented in that the motor speed is calculated by a frequency of the applied current in the low-speed control step or the parallel control step.

### BRIEF DESCRIPTION OF THE DRAWINGS

FIG. 1 is a rotor configuration of a typical sensorless BLDC motor;

FIG. 2 is a block diagram of a typical sensorless BLDC motor control apparatus;

FIG. 3 is a block diagram of a sensorless BLDC motor control apparatus;

FIG. 4 is another block diagram of a sensorless BLDC motor control apparatus;

FIG. 5 is a block diagram of a sensorless controller;

FIG. 6 is a flow chart showing a method of controlling a sensorless BLDC motor;

FIG. 7 is a flow chart showing another method of controlling a sensorless BLDC motor;

FIG. 8 is a timing chart showing increasing frequency of a voltage applied to the BLDC motor; and

FIG. 9 is a timing chart showing increasing frequency of a current applied to the BLDC motor.

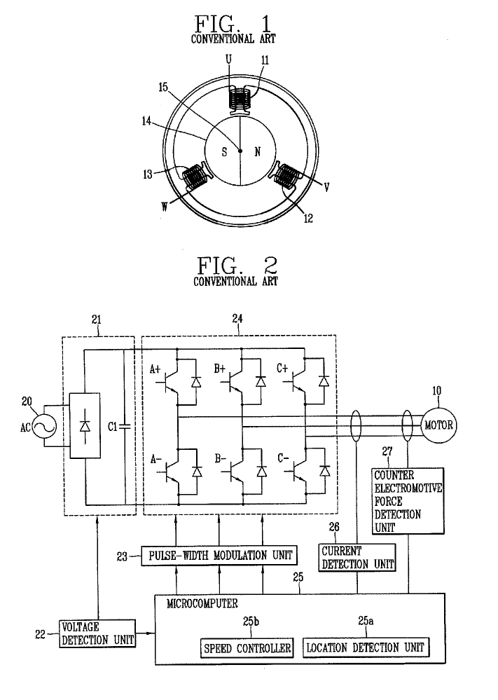

### DETAILED DESCRIPTION

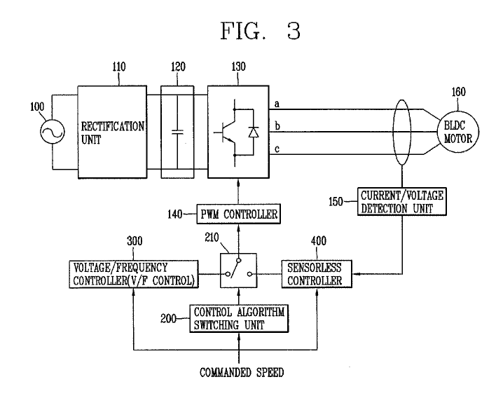

Referring to FIG. 3, a sensorless BLDC motor control apparatus may to include a rectification unit 110 and a smoothing capacitor 120 configured to convert a commercial power 100 into a direct-current power, an inverter 130 configured to convert a direct-current voltage of the smoothing capacitor 120 into a voltage having a frequency driving a BLDC motor 160, a current/voltage detector 150 is configured to detect a current and voltage of the motor, a PWM controller 140 configured to control a switching of the inverter 130, a control algorithm switching unit 200 configured to select a controller of the motor 160 based on the motor speed, thereby a voltage/frequency controller 300 and a sensorless controller 400 being selected by the control algorithm switching unit 200 to control the PWM controller 140.

The voltage/frequency controller 300 outputs a low-speed control signal to the PWM controller to increase frequency of the voltage applied to the motor 160 based on an externally inputted speed or a preset command speed.

The voltage/frequency controller 300 increases frequency of the applied voltage to reach the command speed until the speed of the motor 160 passes a low-speed region. For example, voltage/frequency controller 300 does not detect motor speed, but determines the motor speed by using an open-loop control method because the motor speed could be identical to a frequency of the applied voltage in case when the frequency of an input power gradually increases.

Referring to FIG. 5, the sensorless controller 400 may include a main controller 410 for generating and outputting an estimated location of the motor rotor and an estimated speed of the motor based on a current and voltage of the motor, a current converter 420 for receiving a 3-phase current of the detected motor and converting into q-axis and d-axis currents which are synchronous coordinate currents and outputting them, a speed controller 430 for comparing an command speed with an estimated speed of the motor to generate and output a q-axis order current, a current controller 440 for generating and outputting the q-axis order current and d-axis order current, and is a q-axis command voltage and a d-axis command voltage based on the q-axis current and the d-axis current, and a voltage converter 450 for converting the q-axis command voltage and d-axis command voltage into an α-axis command voltage and an β-axis command voltage on the synchronous coordinate and outputting them.

The command voltage outputted from the voltage converter 450 is sent to the PWM controller 140, and the PWM controller 140 controls a switching of the inverter 130 to drive the motor 160 in a high-speed region.

For example, the sensorless controller 400 compares an estimated speed based on a current and voltage detected from the motor 160 with the command speed in order to control a speed of the motor after the speed of the motor reaches the high-speed region.

The control algorithm switching unit 200 selects one of the voltage/frequency controller 300 and the sensorless controller 400 based on the speed of motor or other reference value such as a predetermined time

In some examples, the control algorithm switching unit 200 selects the voltage/frequency controller 300 if the command speed corresponds to a low-speed region, and selects the sensorless controller 400 if the command speed corresponds to a high-speed region. Alternatively, the controlling control to algorithm switching unit 200 may control the switch 210 when a predetermined time is passed from starting rotation of the motor 160 (e.g., 1 sec).

In case where the command speed is driven in a region between the low-speed region and the high-speed region, the control algorithm switching unit 200 allows the voltage/frequency controller 300 to control the speed of the motor, and allows the sensorless controller 400 to observe the location of a rotor of the motor.

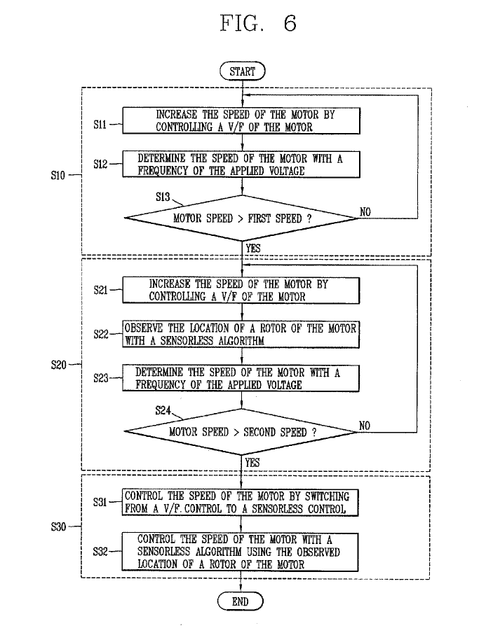

The control algorithm switching unit 200 may include a switch 210 for selecting either one of the controllers of the motor based on the command speed. Referring to FIG. 6, a method for controlling a sensorless BLDC motor may include a first step (SW) that is increasing frequency of the applied voltage while the motor speed is within the low-speed region, a second step (S20) that is increasing a frequency of the applied voltage until the motor speed reaches the high-speed region and observing the location of a rotor of the motor, and a third step (S30) that is controlling the motor speed based on the observed location of the rotor when the motor speed reaches the high-speed region or a predetermined time is calculated.

In the first step (S10), for example, in response to a start instruction, a revolution speed of the motor is increased from a stop state of the motor 160 by gradually increasing a frequency of the applied voltage by using a voltage/frequency control method (S11). In this case, for example, the motor speed is determined by a frequency of the applied voltage, and thus the motor speed is calculated from the frequency of the applied voltage (S12). Then, it is determined by the control algorithm switching unit 200 or sensorless controller 400 whether or not the calculated motor speed reaches a preset speed, namely, a first speed which is a maximum speed of the low-speed region (S13).

In the second step (S20), if the motor speed reaches the preset speed, then a frequency of the applied voltage is increased until the motor speed reaches the high-speed region (S21), and an amount of voltage that is applied to the motor is determined by considering a counter electromotive force being increased in proportion to the motor speed. In this step, the location of a rotor of the motor is observed based on a current and voltage of the motor detected by the current/voltage detecting unit 150 (S22). Then, it is determined whether or not the motor speed reaches a second preset speed which is a minimum speed of the high-speed region (S23).

In the third step (S30), a motor speed controller is switched from a frequency control of the applied voltage which is the open loop control to an estimated speed control which is a closed loop control thereof when the motor speed enters the high-speed region (S31), and the motor speed is controlled by a sensorless algorithm that is estimating the motor speed based on the observed location of a rotor of the motor (S32).

In the first step (S10) or the second step (S20), a speed of the applied voltage is calculated by a frequency of the applied voltage (S12, S23). In the first step (S10) or the second step (S20), frequency of the applied voltage is increased to follow the inputted command speed while the applied voltage may be maintained at a predetermined value. In this implementation, the command speed increases at least one time in the first step or the second step. So, the frequency of the applied voltage is increased at least one time to follow the command speed as a first target speed.

The motor 160, in this implementation, is a sensorless BLDC motor with a 180-degree conduction method, which is also referred to as a space vector control method.

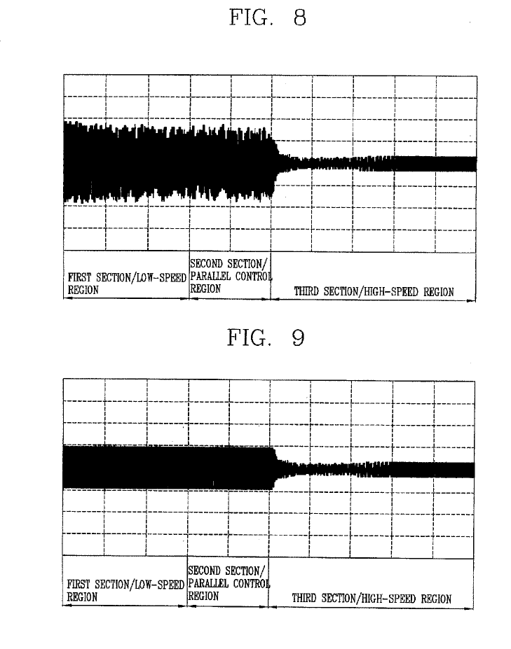

As shown in FIG. 8, a speed of the motor is driven at a low speed by increasing frequency of the voltage applied to a BLDC motor using the open loop control in the first section. When the motor speed reaches a preset speed, namely, a second section, the speed starts to be increased by controlling the BLDC motor with an open loop control while location of a motor rotor is being observed by sensorless controller 400 by using a sensorless algorithm.

In some examples, the motor speed is operated in parallel by using a speed control algorithm (V/F control algorithm) of the motor and also using a location observation algorithm (sensorless algorithm) of the motor rotor.

When the motor rotor reaches a higher constant speed, namely, a third section, it will be switched to a sensorless algorithm to control the speed of the BLDC motor and a result of the observed location of the rotor in the second section is used to control the motor 160.

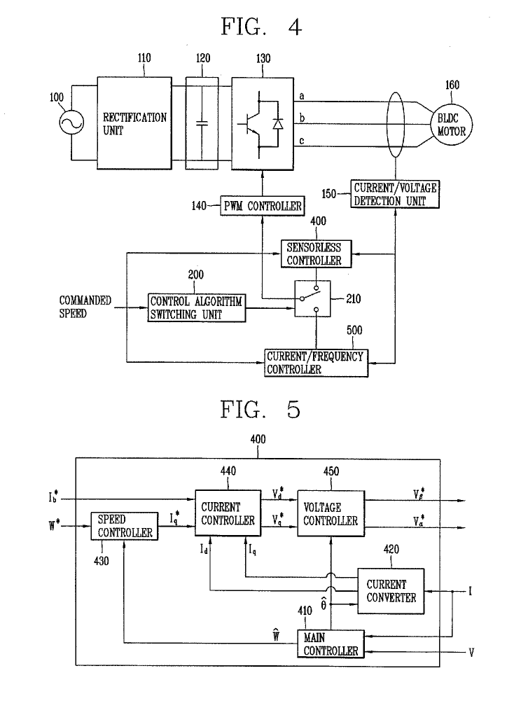

Referring to FIG. 4, an apparatus for condoling a sensorless BLDC motor may include a rectification unit 110 and a smoothing capacitor 120 configured to convert a commercial power 100 into a direct-current power, an inverter 130 configured to convert a direct-current voltage of the smoothing capacitor 120 into a voltage having a frequency driving a BLDC motor 160, a current/voltage detector 150 configured to detect a current and voltage of the motor, a PWM controller 140 configured to control a switching of the inverter, a control algorithm switching unit 200 configured to select a controller of the motor 160 based on the motor speed or other reference such as setting a predetermined time period, and a current/frequency controller 500 and a sensorless controller 400 being selected by the control algorithm switching unit 200 to control the PWM controller 140.

During an initial start-up, the current/frequency controller 500 sets a frequency of the applied current based on an externally inputted or preset command speed and outputs a low-speed control signal to the PWM controller 140 by increasing frequency of the applied current from the stop state.

For example, the current/frequency controller 500 gradually increases frequency of the applied current based on the command speed until it reaches the command speed of the motor, thereby gradually increased speed of the motor 160 from the stop state within a low-speed region. In this case, the frequency of the applied current is increased to sufficiently follow the command speed without stepping out of the motor.

The current/frequency controller 500 may maintain the applied current within a predetermined current range based on an amount of current of the motor detected by the voltage/current detection unit 150. Thus, it may prevent the motor from being damaged due to an over-current flowing into the motor by the overload during an initial start-up.

In the low-speed region, the current/frequency controller 500 does not detect the motor speed, but determines a frequency of an input current as the motor speed. For example, an open loop method will be used for the speed of the motor in the low-speed region.

In the high-speed region, the sensorless controller 400 outputs a high-speed control signal to the PWM controller 140 based on a compared difference between a command speed of the motor and an estimated speed of the motor, thereby controlling the motor speed. Here, whether or not being corresponding to the high-speed region is determined by the current/frequency controller 500 through checking whether or not a frequency of the applied current reaches a second speed which is a lower limit speed of the high-speed region.

The sensorless controller 400 controls motor speed to follow a command speed by comparing an estimated speed of the motor based on a current and voltage of the motor with the command speed of the motor after the motor speed reaches the high-speed region.

The sensorless controller 400 may include a main controller 410 for generating and outputting an estimated location of the motor rotor and an estimated speed of the motor based on a current and voltage of the motor, a current converter 420 for receiving a 3-phase current of the detected motor and converting into q-axis and d-axis currents which are synchronous coordinate currents and outputting them, a speed controller 430 for comparing an command speed with an estimated speed of the motor to generate and output a q-axis order current, a current controller 440 for generating and outputting the q-axis order current and d-axis order current, and a q-axis command voltage and a d-axis command voltage based on the q-axis current and the d-axis current, and a voltage converter 450 for converting the q-axis command voltage to and d-axis command voltage into an α-axis command voltage and an β-axis command voltage on the synchronous coordinate and outputting them.

The command voltage outputted from the voltage converter 450 is sent to the PWM controller 140, and the PWM controller 140 controls a switching of the inverter 130 to drive the motor 160 in a high-speed region.

Consequently, the sensorless controller 400 compares an estimated speed based on a current and voltage detected from the motor 160 with the command speed in order to control a speed of the motor after the speed of the motor reaches the high-speed region. Here, the command speed in the high speed region may be a second target speed of the BLDC motor control apparatus.

The control algorithm switching unit 200 selects whether the motor 160 is controlled by the current/frequency controller 500 or by the sensorless controller 400 based on the speed of motor or counting a predetermined time

In some examples, the control algorithm switching unit 200 selects the current/frequency controller 500 if the motor speed corresponds to a low-speed region, and selects the sensorless controller 400 if the motor speed corresponds to a high-speed region. Alternatively, the control algorithm switching unit 200 selects the current/frequency controller 500 if the predetermined time reaches from starting operation of the motor 160.

In case where the command speed is driven in a region between the low-speed region and the high-speed region, the control algorithm switching unit 200 allows the current frequency controller 500 to control the speed of the motor, and allows the sensorless controller 400 to observe the location of a rotor of the motor.

The control algorithm switching unit 200 may include a switch 210 for selecting either one of the controllers of the motor based on the command speed.

The motor 160 may be a sensorless BLDC motor with a 180-degree conduction method.

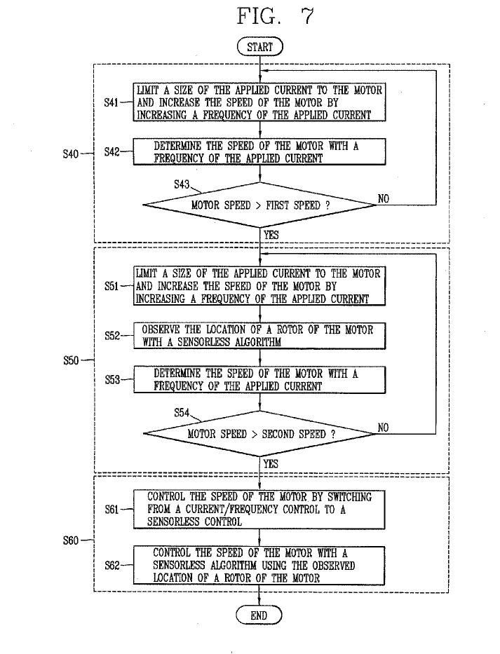

Referring to FIGS. 7 and 9, a sensorless BLDG motor control method may include a low-speed control step (S40) that is increasing the motor speed by increasing frequency of the applied current to follow a command speed, a parallel operation step (S50) that is controlling the motor speed based on a frequency of the applied voltage and observing the location of a rotor of the motor, and a high-speed control step (S60) that is controlling the speed of the motor based on a compared difference between an estimated speed of the motor estimated by a current and voltage of the motor and a command speed of the motor.

In the low-speed control step (S40), the speed of the motor 160 is gradually increased to follow a frequency of the applied current based on the command speed in a low-speed region. In this implementation, an amount of the applied current may be maintained within a predetermined current range of the motor (S41). As a result, it may be possible to reduce the motor from being damaged by an over-current during its initial start-up.

The motor speed is determined by a frequency of the applied current (S42), and it is compared with a first speed which is a preset upper limit speed of the low-speed region in order to determine whether or not a control step of the motor is performed by a parallel operation step (S43).

In the parallel operation step (S50), the frequency of the applied current is gradually increased while limiting an amount of the applied current within a is predetermined current range of the motor until the speed of the motor reaches a second speed which is a lower limit speed of the high-speed region (S51). At the same time, the location of a rotor of the motor starts to be observed based on a current and voltage of the applied current (S52).

The speed of the motor is determined by a frequency of the applied current similarly to the low-speed control step (S53), and it is compared with a second speed which is a preset lower limit speed of the high-speed region to determine whether or not a control step of the motor is performed by a high-speed control step (S54).

In the high-speed region (S60), the speed of the motor is switched to a sensorless controller 400 from current/frequency controller 500 based on the speed of the motor 160 reaches the second speed, and then the motor speed is controlled by estimating the speed of the motor based on the observed location of the motor rotor. As an example, the first speed or the second speed is replaced by a first predetermined time period and a second predetermined period, respectively. From the start, if the first predetermined time period reaches, the parallel operation step (S50) starts and then if the second predetermined time is reaches, the control algorithm switching unit 200 control to the switching unit 210 switched to a sensorless controller 400 from current/frequency controller 500.

As referring to FIG. 9, a speed of the motor is driven at a low speed by increasing a frequency of the current applied to a BLDC motor using an open loop control in the first section. When the motor speed reaches a first predetermined speed, namely, a second section, the speed is increased by controlling the BLDG motor with an open loop control while the location of a motor rotor starts to be observed by using a sensorless algorithm.

When the motor rotor reaches a higher constant speed, namely, a third section which is a high-speed region, it will be switched to a sensorless algorithm to control the speed of the BLDG motor using the observed location of the rotor in the second section.

As illustrated in FIG. 9, an amount of current is limited within a predetermined amount in the first section and the second section which are open loop control sections, thereby protecting the motor from an over-current during an initial start-up thereof.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. An apparatus for controlling a BLDG motor comprising:
a frequency controller configured to increase frequency of a drive signal that is applied to the motor to promote motor movement to a first target speed at a relatively low speed region;
a current and voltage detecting unit configured to detect a current or voltage of the motor;
a sensorless controller configured to observe location of a rotor of the motor at the relatively low speed region, and provide a control signal to the motor by comparing a second target speed with an estimated speed based on the detected voltage or current of the motor at a relatively high speed region; and
a control unit configured to select one of the frequency controller and the sensorless controller based on determination that the relatively low speed region is finished.

2. The apparatus for controlling the BLDC motor of claim 1, wherein the control unit selects the frequency controller when the command speed corresponds to the relatively low speed region.

3. The apparatus for controlling the BLDC motor of claim 1, wherein frequency of the drive signal is frequency of a drive voltage signal.

4. The apparatus for controlling the BLDC motor of claim 1, wherein frequency of the drive signal is frequency of a drive current signal.

5. The apparatus for controlling the BLDC motor of claim 1, wherein the sensorless controller observes the location of a rotor of the motor after the frequency controller controls motor speed for a predetermined time from a state of start.

6. The apparatus for controlling the BLDC motor of claim 1, wherein the to control unit comprises:
a switch configured to select one of the frequency controller and the sensorless controller.

7. The apparatus for controlling the BLDC motor of claim 1, wherein the frequency controller increases frequency to reach the command speed that is increased in the first speed region.

8. The apparatus for controlling the BLDC motor of claim 1, wherein the controller configured to select the sensorless controller based on the speed of the motor.

9. An apparatus for controlling a BLDC motor comprising:
a frequency controller configured to provide at least one frequency of a drive signal to the motor by using an open loop control method to promote motor movement to a first target speed at a relatively low speed region;
a current and voltage detecting unit configured to detect a current or voltage of the motor;
a sensorless controller configured to observe location of a rotor of the motor in the relatively low speed region, and provide a control signal to the motor based on a difference between a second target speed of the motor and an estimated speed of the motor based on the detected voltage or current of the motor at a relatively high speed region; and
a control unit configured to select the frequency controller or the sensorless controller based on determination that the relatively low speed region is finished.

10. The apparatus for controlling the BLDC motor of claim 9, wherein frequency of the drive signal is frequency of a drive voltage signal.

11. The apparatus for controlling the BLDC motor of claim 9, wherein frequency of the drive signal is frequency of a drive current signal.

12. The apparatus for controlling the BLDC motor of claim 9, wherein the frequency controller increases frequency of the drive signal to promote movement motor to increased first target speed.

13. The apparatus for controlling the BLDC motor of claim 9, wherein the controller configured to select the sensorless controller based on the speed of the motor.

14. The apparatus for controlling the BLDC motor of claim 13, wherein finishing the first speed region is determined that the first target speed becomes a predetermined speed.

15. The apparatus for controlling the BLDC motor of claim 13, wherein to finishing the first speed region is determined when the sensorless controller observes the location of the rotor for a predetermined time.

16. A method for controlling a BLDC motor comprising:
increasing frequency of a drive signal applied to the motor by using an open loop control method to promote motor movement to a first target speed at a relatively low speed region;
observing a position of a rotor of the motor by a sensorless controller based on detection of a current or a voltage of the motor;
in response to detection of an end point of the low speed region, converting a motor control mode to a closed loop control method to control the motor movement by the sensorless controller; and
controlling the motor speed to follow a second target speed based on a difference between an estimated speed by detection of the current or the voltage of the motor and the second target speed at a relatively high speed region.

17. The method for controlling the BLDC motor of claim 15, wherein the converting step comprises:
switching the motor speed control mode from a frequency control to an estimated speed control thereof when the motor speed reaches the high-speed region.

18. The method for controlling the BLDC motor of claim 16, wherein frequency of driving signal is frequency of the drive voltage signal.

19. The method for controlling the BLDC motor of claim 16, wherein frequency of the drive signal is frequency of the drive current signal.

20. The method for controlling the BLDC motor of claim 18, wherein the drive voltage signal is maintained at a fixed level.

21. The method for controlling the BLDC motor of claim 19, wherein the drive current signal is maintained at a fixed level.
